(19) United States
(12) Patent Application Publication
(10) Pub. No.: US 2013/0233974 A1
(43) Pub. Date: Sep. 12, 2013

(54) ENERGY SUPPLY METHOD FOR SPACECRAFTS-ACCUMULATORS

(71) Applicant: Alexander Olegovich Maiboroda, Rostov-na-Donu (RU)

(72) Inventor: Alexander Olegovich Maiboroda, Rostov-na-Donu (RU)

(21) Appl. No.: 13/988,720

(22) PCT Filed: Jan. 11, 2011
(86) PCT No.: PCT/RU2011/000002

§ 371 Date: May 21, 2013

(30) Foreign Application Priority Data
Nov. 22, 2010 (RU) 2010147704

(51) Int. Cl. B64G 1/40

(52) U.S. Cl. CPC B64G 1/409
USPC 244/158.2

(57) ABSTRACT

The invention relates to the energy provision of space transport systems and to the organization of a load flow between spacecraft in planetary orbits. The method comprises a spacecraft tank trapping and accelerating atmospheric air and loads located in the trajectory of movement thereof. The loads are transported beforehand to said trajectory by corresponding spacecraft, including suborbital spacecraft, and are then transferred to other spacecraft. Velocity losses of the spacecraft tank due to the trapping and accelerating of atmospheric air, loads and to aerodynamic drag are compensated for by a propulsion unit. The propulsion unit may use reactive engines—with consumption of part of the incoming load—or electrodynamic cable systems. Operation of the propulsion unit of the spacecraft tank is ensured by a supply of load energy carriers using atmospheric gases. Furthermore, an interorbital circulation system of said load energy carriers, with recovery of the energy thereof in other spacecraft for repeated use in a spacecraft tank, is established. The invention is directed towards reducing specific waste in the transporting of loads into space with an accompanying improvement in the overall mass characteristics of the spacecraft tank energy unit and an increase in the ecological safety of the load flow.

The invention relates to space transportation systems and their power supply, methods of delivery of cargo to space and freight turnover between spacecraft.

Industrialization of space means the gradual transfer of manufacturing of products and energy from the Earth to the space. This requires a much cheaper way of transportation of materials and equipment from Earth to low near-earth orbit, and with her into deep space, and the reverse flow from the moon and asteroids into low near-earth orbit. Practiced technology is not able to provide a full-scale industrialization of the extraterrestrial space. Significant reduction in the unit cost of delivery of cargo into space while ensuring the environmental safety of freight flow is an important issue of cosmonautics.

Excisting a group of technical solutions of said problem. Known the project of mr. C. Demetriadi, which called PROF AC (PROpulsive Fluid Accumulator), (K. Gathland. Space technology. Illustrated Encyclopedia). The essence of the project is that the cargo, in this case the components of rocket fuel, is taken directly from the atmosphere. The apparatus “PROFAC” equipped by electric rocket propulsion system, in which the outflow velocity of the working substance exceeds the velosity of substance coming from the atmosphere. Thus, provides a high proportion of the payload in the total mass of coming air owning to a small share of the substances consumed in the electric motor unit. PROFAC, moving in an orbit near the border of dense layers of the atmosphere, captures the thin air, compresses it through a gas-dynamic compression into intakes and compressors, cools and releases liquid oxygen. The remaining nitrogen PROFAC uses in nuclear electric propulsion to compensate for aerodynamic resistance. The method, implemented in the project PROFAC has advantages due to the fact that where is using electrorocket engines with long life and low cost of operation.

Commentators of the project <PROFAC> note that at an altitude of 100 km. air pressure at the inlet to the heat exchanger is very low, so may require additional systems-blowers (cryocompressors) or adsorption devices, freeze (V. P. Burdakov, Y. I. Danilov: Physical problems of space traction energetics.—Moscow, Atomizdat, 1969). Thus, while the processes of accumulation of air by orbital apparatus apply to almost all known in vacuum techniques methods of gas molecules binding, including chemical methods, in the present invention is not provided for the use of exothermic reactions as an energy source for the propulsion system. On the contrary, the process of accumulation of air on board artificial satellites were seen as extremely energy-intensive process.

Despite the economic attractiveness, placing of operating nuclear reactor at extremely low orbit in the upper layers of atmosphere is the main disadvantage of PROFAC. International agreements forbid a placement of nuclear reactors at altitudes below 800 km.

One of the options for addressing the main disadvantage of this method is the accumulation of atmospheric oxygen and nitrogen with low-orbit spacecraft-accumulator (SCA) with a remote power supply to medium-altitude energy emitting laser systems (Eskov Y. M. Environmentally friendly world power generation and astronautics in XXI century//Academy of Trinitarism.—Moscow: E1 277-6567, the publication JS214590, 03.10.2007, p. 41-45). The system that implements this method, consists of a group of space energy emitting stations (SEES), which provide a constant power suppling of several spacecrafts-accumulators on orbits whose altitude of about 105 km. As space energy emitting stations uses a system of energy conversion of solar radiation and its transmission to the spacecraft-accumulator—satellite solar power station, such as the infrared laser with the thermal heating by solar radiation. Instead of nuclear power generator in this system uses a thermal turbo electomachine converter.

The main advantage of the system of spacecraft-accumulator with remote power supply from laser space energy emitting stations unlike spacecraft-accumulator according with system PROFAC with power supply from a nuclear reactor is to ensure environmental safety in the event of an emergency situation.

The disadvantage of this system is the failure in the propulsion system of heat energy in the order of 30 MJ/kg, released by the accumulation of air in the process of its braking relative spacecraft-accumulator. In terms of the substance, accumulated in the form of oxygen is 129 MJ/kg of heat losses.

All the above methods are intended for the collection and storage of gaseous material from the Earth's atmosphere and subsequent getting one of the components of the fuel-oxidant, but it does not solve the problem of delivery in to the space of other raw materials, including solids. That is the problem of obtaining fuel in orbit only partially solved, and the delivery of other types of cargo in to the space in this way is generally impossible.

In the patents U.S. Pat. No. 4,775,120, U.S. Pat. No. 5,199,671 solved the problem of delivery to space of various solid materials from the Earth by shock acceleration transmitted by inelastic impulse of the kinetic energy of the load of extraterrestrial materials. Extraterrestrial materials sent by spacecraft, based on the surface of the moon and on the orbits in the near-lunar space. In accordance with the contents of the abovementioned U.S. patents, for receiving loads from the Earth and the Moon using a massive low-orbit artificial satellite. On the basis of satellite by shocks to transfers the impulse of movement from the high-speed Moon loads to the low-speed earth loads. So, rather than to guide the rocket to an altitude low-orbital base and speed up it for the full alignment of velocities, missiles, used to delivery a loads by described method, starting strictly in a vertical direction, release the load and drop down to the Earth, where its servicing and re-used. Released load positioned so that it is entered in a large aperture of chamber used for receiving of loads, then load inside the chamber is collide with the large mass of material near the center of the chamber so that the load stay inside the chamber and the chamber's walls remain intact. A load from the Earth at a speed of 8 km/s coming through the front inlet of chamber, and loads of lunar material at a speed of 11 km/s coming through the rear inlet of chamber with a relative velocity of about 3 km/s. As the vector sum of the moments of material sent from Earth and sent fron the Moon is approximately eqally to zero by proper selection of the mass, the height and velocity of the satellite used for obtaining loads remain practically unchanged.

The chamber, which used for receiving of loads, is placing on a very low-Earth orbit by the using of vertical tether whose length of about 100 km. from the center of mass of the satellite system, which also has the upper block of mass, at an altitude of 100 km. from the center of mass. In this vertical satellite system with two large blocks of masses, a best location of the receiving chamber is a lower block, as it is easier (cheaper due to fuel consumption, etc.) to transporting loads from the Earth on a lower height. Atmospheric air resistance related to the upper block of mass is much smaller, thus a production base with mirrors and solar panels is optimally to place there. Preference should be given to the transportation of dry materials, water and other substances for recycling in to a base-counterbalance in which for produce of hydrogen and oxygen can be used electrolysis, as well as used equipment for rectification of lunar raw materials and manufacture of cables for tethers. It is also possible a development of greenhouses on the station that require a lot of space and on which implementing the process recycling of waste into food products.

The main advantage of the abovementioned method of use of spacecraft-accumulator for the delivery of a solid load into orbit with the acceleration by means to almost free kinetic energy of the lunar material ejected by near-lunar spacecraft, is the use of cheap and reliable single-stage rockets with a large capacity, which in a ten times reduces the cost of delivery loads into the space.

In this energy supply method for a loads delivery process, the author indicates on possible use of thermal energy generated in the inle chamber for the loads, for example, for heating, excluding the possibility of using this type of energy directly to deliver the loads. This disadvantage is obviously stipulated by the complexity of raising a temperature of buffering agent for significantly higher sense than 200 degrees of Celsius for obtaining a practically significant efficiency of heat using in result of the need to put out in the receiving chamber explosively blows of loads which have excessively large mass of buffering agent (in hundreds times greater than the mass of the load). The large mass of a buffer substance, thus inevitably reduces the temperature drop to almost unacceptable levels. The author emphasizes the fact that although the substance is moving at a speed of about 7400 m/s, it has kinetic energy of about 6500 calories per gram, 1 gram of weight, however, this substance when mixed with the liquid inside the chamber (buffering agent), the average increase of all of these materials' temperature is not more than few degrees of Celsius. In fact, in this way the author says only that most of kinetic energy of the load with the help of heat exchangers can be converted into useful thermal energy and thus prevents the reverse conversion of the thermal energy into useful kinetic energy. In addition, the method does not provide energy exothermic reactions of substances delivered on board of the spacecraft-accumulator, for example, water or oxygen with aluminum, magnesium or iron loads for the delivery of kinetic energy, although he acknowledges that the various types of loads can be carried out chemical reactions with certain materials due to high localized heating in the collision, but these chemical reactions are considered to be negative and virtually useless for the spacecraft-accumulator processes.

In the invention RU2398717, chosen as a prototype, a weight of buffering agent repeatedly reduced by the proposed method of the reception of loads. The method is to first put into orbit spacecraft-accumulator, to capture and acceleration of loads subject to the movement of the apparatus-accumulator, their accumulation and further transfer to other space vehicles, as well as compensation for loss of speed of apparatus-accumulator from seizing loads and air resistance. Launching of loads with suborbital speed by varied ways with crossing of trajectory of spacecraft-accumulator for the time, which necessary to their capture by apparatus-accumulator. Release of the loads in the way of spacecraft-accumulator is a lot of small portions to be allocated to a given trajectory of spacecraft-accumulator, which is then in the form of an extended cloud of discrete particles or continuous flow of solids or liquids into the chamber of receiving loads, where the leveling speed of load and of spacecraft-accumulator. Loss compensation rate of spacecraft-accumulator from the capture of load and air resistance are the propulsion system (PS). As the PS can be used a rocket systems (e.g electrorocket engines, solar thermal rocket engines and others), and non-rocket systems that do not require the active substance, such as electrodynamic cable system (ECS), which is used to create thrust Ampere force, working with the ionosphere and magnetic field of the planet. Working agent for reactive PS enters into the spacecraft-accumulator with the load. Power supply of PS imply by a satellite solar power station (SSPS), which connected to the spacecraft-accumulator. When using ECS as PS, spacecraft-accumulator and SSPS can be interconnected via cable of cable motor that provides take-out of chamber at extremely low altitude and solar power at the height of minimal aerodynamic resistance.

The main advantage of this method is to feed the load to spacecraft-accumulator by steam (flow) of the substance, which substantially reduces the mass of the buffer material (brake environment) and receiving chamber itself. However, it is an advantage not being used to produce high heat and continue to use this form of energy directly to deliver the load. On the contrary, generated heat is not used and dumped into space by radiators emitters. In addition, in the present invention provided a delivery on board of spacecraft-accumulator of various substances, a chemical compound which could under certain circumstances be a source of energy for propulsion spacecraft-accumulator, but in this method said possibility is not used.

Technical problem solved by the invention is a method of energy supply of spacecrafts-accumulators, allowing to reduce the unit cost of delivery of loads in space, while reducing the weight and size characteristics of power plants and improving environmental safety traffic by organizing interorbital circuit materials-energy resources and improve specific propulsion power and efficiency through the use of chemical energy materials, in whole or in part forming an incoming load, and the kinetic energy of the load (the system of loads and SA), released in the form of heat in the relative deceleration received loads.

This technical result is achieved with the proposed method of spacecraft-accumulator energy supplying. The method includes the capture and acceleration by the spacecraft-accumulator of atmosphere air and loads, placed on the path of motion and pre-discarded by suborbital and space spacecraft, and their transfer to other spacecrafts. A loss compensation of the spacecraft-accumulator speed from the capture and acceleration of atmospheric air, loads and aerodynamic resistance is realized by the propulsion system powered from the satellite station. Propulsion systems are used as reactive type with using a flow of incoming load or air, and as the electrodynamic type, based on the cable motor-generator, forming a vertical satellite system. The work of the propulsion system of spacecraft-accumulator ensures by delivery of loads-energy carriers with using of atmospheric gases. In this case, organized the system of interorbital circulation of loads-energy carriers for recovery of loads energy on other spacecrafts for re-use in spacecraft-accumulator.

The proposed method can reduce the unit cost of delivery of loads into space as a result of increased freight-flow in one and half or two times compared with analogs through the use of the heat generated by the relative braking of loads in spacecrafts-accumulators for power supplying of PS. Furthermore, the method involves the use of loads as energy-carriers for energy supplying of PS that greatly reduces the need to use other energy sources, including solar energy, which requires the use of bulky structures. Thus, a significant reduction or full elimination of the use of solar energy allows move to a highly efficient and compact plants with high power density and efficiency, while reducing the overall weight and size characteristics of power plant.

The method involves organizing interorbital circulation of substances-energy Carriers—with waste free reuse of substances-energy carriers with recovery of consumed energy on other spacecrafts remote from the Earth that increases the cost-effectiveness and environmental safety of traffic.

There are several basic levels of the proposed method of spacecraft-accumulator power supplying: energy supply by fuel delivery from the Earth together with the supply of energy from the satellite solar power station; energy supplying by fuel delivery from Earth, in combination with the communication of the missing kinetic energy by an additional transverse (horizontal) acceleration of loads to suborbital launchers; energy supplying by fuel delivery from Earth, in combination with heat recovery (from braking of accumulated substances) and its conversion to kinetic energy; energy supplying by fuel delivery by spacecrafts, based on the interorbital circulation of regenerable substances—energy carriers; energy supplying based on a combination of the following methods. In this case, the propulsion system of spacecraft-accumulator can be as in the form ECS and cable engine, so and in form of electrorocket engine or combined type.

Delivery of loads to low-Earth orbit in the energy aspect means the transfer of kinetic energy in the amount of more than 30 MJ/kg, if we consider only the transverse component of the velocity. In process of launching on an equatorial orbit at an altitude of 100 km. in the direction of rotation of the Earth, the energy of start-up, determined by the transverse velocity, will be less and will be come to 27.3 MJ/kg. In certain and practically important cases in the delivery of loads in the space, loads and energy carriers which ensures the transfer of the kinetic energy to the load, divided and, as a rule, energy carriers combined with the working substance.

Since the power consumption of the best rocket fuels is in the range of 9-13 MJ/kg and a missile load delivery method into space needs to consume energy to accelerate mass energy source, for 1 kg of freight consumes energy capacity of 220-250 MJ. The spacecraft accumulator with a remote energy supply in the embodiment with an electric propulsion motor (with an efficiency equal to 0.5) provides significant energy consumption for accumulation of 1 kg of load or air—110-120 MJ/kg (in the electric form). There are no chemical carriers having such energy capacity, however the spacecraft accumulator with a remote energy supply in the embodiment with a cable motor having an efficiency equal to 0.85 (hereinafter the value of the cable motor efficiency is assumed to be 0.85), requires only 32 MJ/kg while moving in the equatorial plane in the direction of rotation of the planet. Some fuels have similar energy—beryllium and oxygen yield 24.4 MJ/kg, lithium and fluorine—23.5 (hereinafter information on the thermodynamic properties is presented according to the web site “XuMuK.ru”), allowing the most part of energy for the remote energy supply to deliver together with load-energy carriers and its large deficit fill up from a solar power plant. The main advantage here is a reduction of area and mass of the solar energy converters several times. If for the basis of the calculations is taken that the conversion of chemical energy of load into electrical energy is carried out in fuel cells with an efficiency equal to 0.8 (hereinafter the value of the fuel cells efficiency is assumed to be 0.8), then loads of beryllium and oxygen reduce the area of solar cells in 2.6 times, and freight of lithium and fluorine in 2.4 times.

Full exemption from bulky solar converters is achieved by negligible forcing of suborbital launch vehicles. A required balance of supply and consumption of energy can provide some additional velocity in the transverse (horizontal) direction to the load.

The next level of energy supply of the spacecraft accumulator significantly reduces velocity gain of suborbital launch vehicles. There is an untapped energy resource—a capture of load by a spacecraft accumulator that leads to a release of heat by a relative braking of the captured material in a load chamber. At the same equatorial orbit it gives 25 MJ/kg of heal energy. Thus, using loads as energy carriers for a spacecraft accumulator provides input of energy in the spacecraft accumulator in the chemical and thermal forms in an amount equal to 51.7 MJ/kg for loads consisting of beryllium and oxygen and equal to 50.8 MJ/kg consisting of lithium and fluorine. In the generation of electric energy in a hybrid-type fuel ceil (including solid fuel) with a real efficiency in the range of 0.8-0.85 and converting braking heat into electricity in combined-cycle plant with an efficiency of 0.6 total output of electric energy of on-board power plant of a spacecraft accumulator will provide a more than 35 MJ/kg for loads-energy carriers, based on beryllium with oxygen and lithium with fluoride, with the need for a rope motor energy of 32 MJ/kg (hereinafter its assumed that combined-cycle plants converting heat into electric energy have an efficiency equal to 0.6).

Loads delivered to orbit by the claimed method is represented by beryllium oxide, lithium fluoride or other products of exothermic chemical reactions, which are then used as structural and similar materials in industrial activities in space. Some of these chemical components are decomposed into source materials for further using them as fuel.

Fuel reprocessing is carried out on the spacecrafts having a higher orbit, which is convenient to use and solar concentrates and solar batteries, as well as referring to altitude of the orbit (800 km) it is allowed to use nuclear reactors.

Oxygen produced by the decomposition of beryllium oxide then enters the long-term orbital propellant storage, and metallic beryllium is back into low orbit to the spacecraft accumulator for reuse, in this case interorbital circulation of fuel enables directing oxygen from the Earth to the spacecraft without beryllium, plus, if necessary, any other loads in view of the fact that in this scheme of circulation of fuel, the actual energy consumption of oxygen in the oxidation of beryllium from the board supply of the spacecraft accumulator reaches 38 MJ/kg.

Similarly, lithium produced by the decomposition of lithium fluoride enters into long-term orbital propellant storage and construction materials, and the fluoride is back into low orbit to the spacecraft accumulator for reuse, in this scheme of circulation of oxidant, the actual energy consumption during the oxidation of lithium fluoride from the board supply of the spacecraft accumulator reaches 88.5 MJ/kg. The excess energy, with the addition of heat from the braking enables to transport together with every 1 kg of lithium 2.6 kg of any other substances during supplies from Earth to the spacecraft accumulator.

In another embodiment, while organization of lithium interorbital circulation and fluorine supplies from Earth, the actual energy consumption of fluoride in the oxidation of lithium using the board supply of the spacecraft accumulation reaches 32.3 MJ/kg. In addition the braking heat emitted by fluoride ultimately provides the energy of 59.6 MJ/kg.

A method for providing a decomposition of chemical reaction products, that is, fuel reprocessing, and the organization of interorbital circulation products of decomposition and synthesis allows to use instead of scarce beryllium and inconvenient fluoride more affordable and convenient material, such as aluminum and oxygen.

Supplies of hydrogen from Earth when it is oxidized by fluoride from the board supply of the spacecraft accumulator release energy of 270 MJ/kg per 1 kg of hydrogen. In addition to this value it is added heat capacity of 27.3 MJ/kg, which raises the specific value of energy supply to nearly 300 MJ/kg. This energy excess allows transporting together with every 1 kg of hydrogen 8.29 kg of any other substances without using of heat generated in the chamber for loads during supplies from Earth to the spacecraft accumulator. With the use of this recourse the weight of additional loads can increase to 16.58 kg per 1 kg of hydrogen. Substitution of fluorine for oxygen does not significantly reduce the production of energy for propulsion of the spacecraft accumulator—power generation drops to 119.5 MJ per 1 kg of hydrogen.

Energy excess during supply of hydrogen from the Earth to the spacecraft accumulator with interorbital oxidant circulation in the form of fluoride or oxygen is convenient for parallel intake of atmospheric oxygen and nitrogen. Then per 1 kg of accumulated hydrogen the spacecraft accumulator could intake from 8 to 16 kg of air.

An air accumulation process by a PROF AC class apparatus can be carried out not only as an additional process of hydrogen flow accumulation but also as an independent process, based on energy release during the exothermic reactions of oxygen and nitrogen with some metals from the regenerating board supply, such as beryllium, zirconium and hafnium. Here the best metal for the price, world reserves and physical and chemical properties is zirconium—oxygen in combination with it releases 45.2 MJ/kg (plus 27.3 MJ/kg of braking heat) and nitrogen releases 26.5 MJ/kg (plus 27.3 MJ/kg).

In spite of the worst parameters, theoretical and practical interest have methods for energy supply of a spacecraft accumulator with a remote control in the embodiment with an electric propulsion and other types of missile remote control.

As mentioned above a spacecraft accumulator with a remote control in the embodiment with an electric propulsion motor (efficiency if equal to 0.5) for accumulation of 1 kg of loads also involves significant power consumption—110-120 MJ/kg. Due to the feet that there is no chemical energy-carriers with such specific energy store, the problem of supply of an electric propulsion in the required amount of energy supply of loads-energy carriers from the Earth is solved by increasing the speed of suborbital rockets-suppliers of loads to the spacecraft accumulator in the transverse (horizontal) direction, so as a store of chemical energy and recoverable relative kinetic energy of loads will provide (at actual efficiency) acceleration of load to full orbital velocity.

For example, acceleration of loads in the transverse (horizontal) direction to the half of the speed of the spacecraft accumulator, which also reduces by half the relative collision velocity of load and the spacecraft accumulator leads to a fourfold reduction in the amount of energy required for the subsequent dispersal of load and adjustment its speed at a rate of the spacecraft accumulator in the chamber for loads. Thus, it is required acceleration of load only to 3692 m/c at altitude of 100 km in the adopted equatorial embodiment. Then, in this case, the best specific impulse for the electronic propulsion will be twice velocity of the loads relative to the spacecraft accumulator—7384 m/s. The kinetic energy of such a jet is 27.3 MJ/kg, and thrust of electric propulsion with consumption per 1 kg of the working substance enables to balance the capture of 2 kg of a load at speed equal to 3692 m/s. At relative deceleration in the spacecraft accumulator of 2 kg of a load heating energy of 13.6 MJ/kg is released. If half of the delivered loads is hydrogen with oxygen, and the second half of beryllium with oxygen (it is also possible lithium and fluorine), the total energy release of the load on board of the spacecraft accumulator will be 13.3 and 24.4 MJ/kg or total 37.7 MJ/kg (obtained water will then be used as the working substance of the electric propulsion). With respect to heating energy from braking, the total amount that is produced on board of the spacecraft accumulator is equal to 51.3 MJ/kg. Within the adopted efficiency for fuel elements and combined cycle power plants and at electric propulsion efficiency equal to 0.72-0.75, energy produced on board of the spacecraft accumulator from energy carriers delivered from the Earth is enough for operation of the electric propulsion.

The same scheme can be significantly improved by replacing the electric propulsion to thermal engines with a working substance as hydrogen. Then every 1 kg of fuel from beryllium and oxygen (or lithium and fluoride), burning in the heat exchanger of the satellite power plant heats directly 1 kg of hydrogen, and this heat is added to braking heat in the chambers for loads of beryllium, oxygen and hydrogen.

If the total heat transfer efficiency reaches 0.72, then the specific impulse of thermal engine with working substance on hydrogen will be about 7400 m/s, that is the same as that in the above embodiment with the electric propulsion, but with a very low consumption of materials in the absence of control devices of thermal and chemical transformation of energy into electrical form. Increasing power density of the remote control in this case is possible in 440 times.

In a certain range of sub-orbital velocity, when the kinetic energy of the load delivered to the spacecraft accumulator, more or equal to half the kinetic energy of the local orbital velocity (moving in the general direction), it is possible to supply the classic rocket fuel, and the use of typical thermochemical rocket engines to compensate braking forces.

As part of an interorbital circulation of substance-energy carriers it is also perspective to use thermal storage substances that use, for example, the effect of the phase transition. This makes it possible to use technical simple recharging schemes of substances-accumulators permitted under high energy supply. To heat a heat accumulator it is better to use the compact sources based on high nuclear reactors, which are allowed in high orbits (over 800 km). It is promising because with relatively simple technology it is possible to use reactors with a heat output of 100 MW. As heat storage substances, it is convenient to use a hybrid of lithium and lithium fluoride. In this scheme the spacecrafts accumulator's power supply is effected by transferring to its board of substances' portions heated on board of high-orbital satellite using a nuclear heater that after selection of heat are transferred back to recharge. For the transformation of heat into electricity on board of the spacecraft accumulator it is possible to use high efficiency combined-cycle plants.

Due to the need to use lower orbits of a satellite-generator of heat, it can be used the mirror concentrators satellites as heaters at altitudes of 350-500 km.

As an additional method for transferring of large amounts of heating energy, it is desirable to transfer components of rocket fuel on board of the spacecraft accumulator, such as hydrogen and oxygen, without accumulation, i.e. subsequent one hundred percent spending in the rocket remote control. In this case, the goal of a procedure is to obtain heat generated during braking of these substances' flow in the chamber for loads that quickly stored on-board thermal accumulators and then is used for a long time.

Consider specific examples of the method for energy supply of the spacecraft accumulator with specific examples. There are two main areas of focus in this method: the first for the spacecraft accumulator with a remote control as EDCS (electrodynamic cable system), for second for the spacecraft accumulator with a rocket remote control.

A spacecraft accumulator with a rope engine is a vertical rope system, the lower part of which is in the form of a chamber for air and loads can be at altitude of 120-150 km, and the upper part with the tanks for storing liquid and solid loads and other accessories at altitude of 200-250 km and above.

The key problem of such a system is in a relatively large flow resistance of the rope on which the lower chamber is hung. By increasing the weight of the chamber and the cross-section of the rope, the proportion of aerodynamic resistance of the rope in the total proportion of atmospheric resistance to the chamber and the rope can be reduced to a certain values, the braking power of the rope can be reduced to a few percent of the total braking power. This way of building mass and size parameters of the spacecraft accumulator may not be acceptable for the deployment phase of the first generations of the spacecraft accumulators. The other way, less material solution is that the rope is covered with absorbents of nitrogen and oxygen. For example, such substances can be zirconium, hafnium, thorium. The rope coating is updated periodically—substances that have reacted with the molecules of air are removed by the automated devices and by the same devices are periodically moved up and down along the rope, applied new portions of absorbents. Substances undergoing chemical reactions with air molecules are sent to regeneration and after the separation of nitrogen and oxygen are re-used as a getter rope coating. Thus, the resistance of the rope is useful and on account of work performance on the accumulation of air in fact is equal to the working resistance of the chamber for air capture.

This technique from all subsequent calculations of the work of the spacecraft accumulator with the low-mounted suction chamber in most cases can eliminate atmospheric drag force acting on the rope, considering theses force as a part of the forces arising from the accumulation of nitrogen and oxygen by means of the main air capture device.

The first or rather an intermediate stage of the method of the spacecraft accumulator energy supply from accumulating by it loads will be the combined use of the proposed method with the method of the prior art, which is useful in cases of applying the spacecraft accumulator with long rope by which the solar power station having a supporting role can be put to a height where the braking forces of residual gases will be sufficiently small. In this scheme, the implementation of the method looks like the launch of a suborbital space launch vehicle almost vertically to the height of the receiving chamber of the spacecraft accumulator, for example, to a height of 120 km. The most favorable fuel will be a pair of beryllium-oxygen. Beryllium is delivered in the form of wire-string or ribbon that stretches along the path of the approaching spacecraft accumulator with two auxiliary devices with a mikro-racket remote control. Oxygen is delivered in the form of one or two jets of supercooled liquid, which is formed along the path of the approaching spacecraft accumulator by side pumping devices and emission in the transverse direction relative to the vertical velocity vector of the space launch vehicle.

Flows of substances included in the receiving chamber, face with a buffer material with a chemical composition, usually similar to their own composition, brakes and heated. Then, in a heated state (under pressure which follows the new portions of incoming loads) are promoted through the heat exchanger of the chamber and give most of its heating energy to the heat storage. The accumulated heat in this sub-option of the method can dissipate through radiators of the spacecraft accumulator and utilized in other more detailed embodiment of the method for power supply of the spacecraft accumulator. And in this case cooled to the required temperature fuel components come into the fuel elements or combined cycle power generating plant. The generated electric energy enters to EDCS and other systems of the spacecraft accumulators. Spent fuel in the form of beryllium oxide is removed from the fuel elements (or from a combustion chamber of a combined cycle gas turbine) and enters the storage tanks of the spacecraft accumulator, where it is stored prior to transfer to other spacecrafts.

An Unwinding speed of a string (wire) is 50-250 m/s, a speed of a liquid jet Ejection—25-100 m/s. The length of the expanded wire made of beryllium and the jet of supercooled oxygen at the time of their capture by the accumulator reaches 700-800 meters. Average weight of the fuel components captured by the spacecraft accumulator for one start of the space launch vehicle is 50 kg. This leads to acceleration of the chamber in the direction opposite to the movement of the spacecraft accumulator and subsequent pendulum vibrations of the lower block on the rope. Braking and vibration parries work of EDCS, shock-absorbers and air resistance and subsequent regurgitation of the loads at the lower block in anti-pendulum oscillations (lower block).

When the dry mass of the lower block of the vertical satellite system, which is in the range of 13.7-20 tons, a mass of the liquid air ballast residue (or high boiling chemical compounds of nitrogen and oxygen), and parts of captured solid loads may increase the mass of the lower block to 50 and more tons. Therefore, if the mass of the captured portion of a fuel component is equal to 50 kg, the lower block obtains a negative speed equal to 1/1000 of a speed of the absorbed portion or 7.372 m/s (for altitude of 120 km). When the acceleration time of 0.1 s an average value of over load for the spacecraft accumulator's lower block will be about 7.5 g, the total deceleration of the rope system will be much less, because of its greater mass and damping of the systems that are due to a significant reversible extension of the rope (minimum several thousand meters) after a collision the chamber with the load, reducing the total acceleration of the system from 7.5 g to the required minimum level.

Loss of the spacecraft accumulator's speed is compensated by acceleration imparted to the system or by the rope electric engine of EDCS. Fuel elements and beryllium oxidized with oxygen (efficiency=0.8) are placed on board of the spacecraft accumulator. Energy generated by fuel from beryllium and oxygen, provides up to 61 percent of the energy required to operate the EDCS. The remaining 39 percent of the energy are produced by the satellite solar power plant. Area and volume of the solar power plant spacecraft accumulator-prototype are eventually reduced by 2.5 times.

The braking impulses from the seizure of loads periodically chum a near-circular orbit of the satellite rope system. To prevent the fall of altitude of the chamber below 110 km, where it starts to flutter, or an increase in altitude of over 120 km, where the deteriorating conditions of the combustion of air and missile power lifting, the rope's length is adjusted.

The next step in the implementation of the proposed method of the spacecraft accumulator energy supply is a complete renunciation to use a solar power plant, and an appeal to the additional kinetic energy from the already used suborbital spacecraft launch vehicle. Energy deficit of renewable solar power plant (in the example above) is equal to 7.65 MJ/kg in the kinetic equivalent. Suborbital space launch vehicle fills this gap by acceleration of the loads in a horizontal (transverse) direction to a speed of 3912 m/s. Relative collision velocity of the load and the spacecraft accumulator decreases by the same amount.

At the same time, while maintaining the space launch vehicle values of the energy support for most cases of using of fuel less caloric than beryllium-oxygen or lithium fluoride, significant results are provided by other, more advanced version of the spacecraft accumulator energy supply—using waste heat released in the chamber for loads. As already mentioned, loads the warmed at a relative deceleration in the camera moving in the heat exchange section of the chamber, equipped with heat storage. Selection of heat from the substance captured by the spacecraft accumulator is carried out in such a way that as it is cooling while advancing through a heat accumulators, the thermal energy storage substances with all the lower temperature phase transition are used. Latent heat of fusion (and/or steam formation) of the thermal energy storage substances are then used to generate electricity in combined cycle plants (efficiency=6). The heat from the relative braking of loads in the spacecraft accumulator covers with the excess the deficit in energy consumption of EDCS.

The use as a load-energy carrier of aluminum-nitrogen fuel reduces the need for the use of solar energy in 3.4 times, the boron-nitrogen fuel reduces the need in 4.3 times, the lithium-hydrogen fuel by 4.9 times, the pair of hydrogen-oxygen in 6.3 times hydrogen-fluorine reduces the need in 6.6 times the fuel of silicon-oxygen reduces in 9 times, a pair of aluminum-oxygen provides a reduction in 12.7 times, while the boron-oxygen fuel reduces the consumption of solar energy in 30.8 times compared with the prototype when the same volume of operation for a load delivery in orbit storage.

The next step in realization of the suggested method of the spacecraft accumulator energy supply is a switch to the usage of additional energy of solar or nuclear power plants located on the other spacecrafts circling in higher orbits with which the space craft accumulator exchanges loads. The loads being transferred from the space craft accumulator to orbital storages in the suggested method of the spacecraft accumulator energy supply are mainly various chemical compounds with fluorine, oxygen, nitrogen and carbon that is convenient for long storage and using as structural materials, including systems of radiation shielding.

However, in many cases space consumers require unoxidized elements, for instance, silicon and aluminium, and also oxygen and carbon in their free forms. At that needs for this or that group of materials received in the result of chemical decomposition of their compounds are also unequal. For instance, decomposition of beryllium oxide for getting oxygen leads to accumulation of beryllium metal surpluses in orbital storages, the beryllium metal being requisite for providing transfer operations in the spacecraft accumulator. Thus, the next step of realization of method naturally follows from space manufacture and transport needs. The stream of loads in the form of exoergic reactions from the spacecraft accumulator to the space vehicles-consumers is expanded by a counter flow of loads from space vehicles to the direction of the spacecraft accumulator in the form of fuel components prepared for energy-release in spacecraft accumulator.

Closed circulation is used for energy feed of accumulation processes of loads instead of solar energy converters when using various low-calorie fuel pairs, for example, such as the above mentioned aluminum-nitrogen, bora-nitrogen, lithium-hydrogen, hydrogen-oxygen, hydrogen-fluorine, silicon-oxygen, aluminum-oxygen, bore-oxygen. And regeneration of the active fuel charges as beryllium-oxygen and lithium-fluorine. Is used for energy supply of interorbital tugs transfers at extremely low altitudes.

Interorbital tugs with propulsion system in the form of electric propulsion and electro-dynamic cable system are used as means of interorbital circulation of materials. Some interorbital tugs function as simplified spacecraft accumulators and simultaneously as refueller mechanisms in order to provide transfer of loads between spacecrafts by means of direct transfer at relative speeds up to 3000 m/s. Tether engine-generators are mainly used to transfer loads in orbits in the altitude range from 200 to 3000.

Use of the waste thermal energy of nuclear power plants which are used on high-altitude satellites as compact energy sources of manufacturing equipment for regeneration of spacecraft fuel charges can be regarded as a completion phase in realisation of the suggested method of the spacecraft accumulator energy supply. Orbital stores of alumina and magnesium oxide, lithium fluoride, lithium hydride, aluminium chloride generated by the spacecraft accumulator functioning enable circulation of heat storages between the spacecraft accumulator and the nuclear commercial plant when using interorbital tugs, equipped with electro-dynamic cable system and electric propulsion. Such a circulation of heat-accumulating substances may be fulfilled jointly with the circulation of chemical compounds. It is also appropriate to use solar heat sources for charging of heat storages.

The method of the spacecraft accumulator energy supply with the heat from the nuclear satellite power plant is realised by means of shuttle working of an interorbital tugs group between upper block orbits of the cable spacecraft accumulator, the group being located on the altitude 200 km, and the spacecraft having a nuclear reactor on the altitude 800 km. When used in a generator regime the tugs equipped with electro-dynamic cable system do not spend the energy on the descent from the nuclear satellite power plant to the spacecraft accumulator for delivery of heat-insulated capsules with heat accumulating substances. And they need to pick up the speed approximately equal to the difference of circular speeds at altitudes of 200 and 800 km, that is to spend energy sufficient for gaining speed equal to 333 m/s, in order to rise in a reverse direction under the influence of electro-dynamic cable system low thrust power to deliver heat storages for recharge. For spacecraft accumulator with the mass equal to 1000 kg the consumption of energy is equal to 55.44 MJ in pure form, and subject to overall efficiency of combined-cycle plant and cable electromotor equal to 0.5, the rise needs 111 MJ of heat energy. When using a heat-accumulating substance such as lithium fluoride with energy volume more than 1 MJ/kg, this requires usage of a heat storage which mass is 100 kg. And on condition that the total mass of heat accumulating substances on a tug board is equal to the half of its mass, a free energy reserve is equal to 400 MJ. When a specific electric power for the load delivery to the spacecraft accumulator is equal to 32 MJ/kg, the mentioned energy reserve is enough for the spacecraft accumulator energy-supply when the spacecraft accumulator accumulates 12.5 kg of the loads directed from the Earth and also for the following delivery of this load mass to any of the circular orbits in the range from 200 to 800 km. The application of lithium hydride having a specific power intensity equal to 2.85 MJ/kg in the composition of the heat storage increases the mass of the loads sent into outer space in one tug trip up to 41 kg.

The method of the spacecraft accumulator energy supply with the energy on basis of returning to the spacecraft accumulator loads from spacecrafts with the nuclear or solar satellite 700 power plant is realised in a similar manner like in the above mentioned scheme, but instead of supplies of heated substance portions to the spacecraft accumulator regenerated fuel charges are supplied to it. For instance, a substance portions circulation on basis of bore and oxygen will increase spacecraft accumulator power supply at the minimum 6.4 times more and instead of 41 kg of loads per energy carrier portion will provide for 262 kg, and if charges on basis of beryllium-oxygen per energy carrier portion are used in the circulation this will provide orbiting of 350 kg of loads instead of 41 kg.

The second direction of the method realisation after the spacecraft accumulator with electric propulsion and electro-dynamic cable system is a method of spacecraft accumulator power supply with a rocket propulsion system. A spacecraft accumulator with a rocket is a system analogous to the construction, realising the prior art. A spacecraft accumulator can also have a rope (a thinner one than electro-dynamic cable system rope) for placing a towed chamber on it, the spacecraft is operated in the non-rope form.

Let us consider a variant of spacecraft accumulator supply with loads-energy resources by a rocket scheme of drafting. A satellite that periodically falls into an elliptical orbit with a low perigee, as a result of getting a retroburn when capturing a load-energy carrier, raised by a suborbital carrier rocket, on a higher circular orbit. The second capture of the load, delivered by a suborbital carrier rocket is realized at perigee. The retroburn from the capture of the second load moves the spacecraft accumulator in a circular orbit, the movement in which in order to accumulate air may take place for some time if the required energy reserve, or the spacecraft accumulator includes electric propulsion at once when orbiting in a low orbit and using the energy reserve received with the loads spires to the previous high circular orbit.

The delivery of loads by suborbital carrier rockets is realised with an additional acceleration in a transverse direction with transferring a forward velocity equal to approximately a half of a spacecraft accumulator local orbital speed. A cycle has the following parameters. A spacecraft accumulator which mass is equal to 7799 kg, moving at the altitude of 184 km and the speed of 7799 m/s collides with a load flow which mass is equal to 50 kg and which has a relative speed equal to 3900 m/s. After the collision the spacecraft accumulator speed decreases by 25 m/s and it goes from a circular orbit to an elliptic orbit with a perigee at the altitude of 100 km. the spacecraft accumulator speed is equal to 7874 m/s. Here the spacecraft accumulator again collides with a load flow which mass is about 50 kg and which has a relative speed equal to 3937 m/s. After the second collision the spacecraft accumulator speed again decreases by 25 m/s and it goes from an elliptic orbit to a circular orbit with an altitude of 100 km. As a result the spacecraft received loads—energy reserves with total mass little less than 100 kg. One half of the loads is represented by a beryllium-oxygen fuel reserve, the second one is represented by a hydrogen-oxygen fuel reserve. Electric power for electric propulsion is generated by means of oxidation of beryllium and hydrogen in the fuel elements and the usage of braking heat in combined-cycle plants. Electric propulsion working agent is water, received by a hydrogen oxidation in a rolling power plant. Electric propulsion efficiency=0.65-0.75. Specific impulse of electric propulsion is approximately equal to 7800 m/s. At consumption of 50 kg of the working element it imparts to the spacecraft accumulator a distinctive speed about 50 m/s which is necessary to spire to the previous orbit. On reaching of the previous orbit the load is passed by interorbital tugs for delivering into orbital storages and space plants and the cycle repeats.

The optimal direction of realisation of the method is a combined use of a spacecraft accumulator with propulsion system both in the form of electro-dynamic cable system and in the form of the rocket propulsion system which are used to provide the highest efficiency of the spacecraft accumulator work.

As an example of such a realisation of the method with reference to the spacecraft accumulator with a combined propulsion system there are two spacecraft accumulators circling in similar orbits in opposite directions and opening the work cycle by loads exchange between each other. The loads exchange is used to produce a retroburn (more economical method without spending of the working agent) and move to the orbit with a low perigee at an altitude about 100 km. The maximum low altitude is used to minimise energy consumption by carrier rockets of the spacecraft accumulator loads during the vertical lift. Capturing of the loads produces a retroburn and such an orbit change that in an extreme case an elliptical orbit transforms in a circular one with an altitude equal to a perigee altitude of the previous orbit. To rise from this orbit rocket propulsion systems are initially used which provide a distinctive speed equal to 60 km and use (partially) nitrogen as an actuating fluid, nitrogen is at the same time accumulated by the spacecraft accumulator (per se forced, for realisation of aerodynamic braking) at low altitudes and on reaching an altitude of about 200 km there is a transfer from rocket propulsion systems to electro-dynamic cable system. For this purpose electro-dynamic cable system rope is wrapped and is unwrapped in a run position in necessary moments of orbit parameters changes of each of the spacecraft accumulators. A subsequent increase of the spacecraft accumulator orbit altitude takes place under the influence of the cable electromotor tractive force.

Loads exchange takes place in a circular orbit with a maximum altitude (−1000 km) for orbits passable by apparatuses during interorbital manoeuvres. Spacecraft accumulator counter orbits pass in a general plane with an altitude distinction in the range 100-1000 m. one of the spacecraft accumulators separates from itself a portion o the load, which is then moved vertically to an orbit level altitude of the counter spacecraft accumulator and fixed at the adjusted altitude at the moment of time close to the moment of passing this orbit region by the apparatus. The counter spacecraft accumulator captures the portion of the load and gets a necessary retroburn. A load mass for this speed of the spacecraft accumulator is selected so that the retroburn from the capture caused the spacecraft accumulator move to an elliptical orbit with the minimal low perigee altitude (−100 km). The heat energy received as a result of the counter loads braking is stored by heat storages.

The same procedure is realised by the above mentioned spacecraft accumulator-receiver of the load with respect to another one. Thus, the two spacecraft accumulators system moves from one orbit to another.

The advantage of spacecraft accumulator power supply with a combined propulsion system according to the method described in two suboptions first consists in solving the problem of a rope aerodynamic resistance at low altitudes, a second in achieving a very small the spacecraft accumulator mass-the captured load mass relation for the considered range of interorbital maneuvers between 100 and 1000 km the spacecraft mass may be only 15 times more than the mass of the captured load-energy carrier.

Thus, the availability of using loads as energy resources implemented in the proposed method allows to reduce specific costs for the loads delivery to space, to reduce the weight and dimensions of power installations, and organizing of interorbital circulation of substances-energy resources allows to improve safety and economic efficiency.

1. A method of spacecraft accumulators energy supply comprising a capture and an acceleration of an atmospheric air and loads which are on the path of spacecraft accumulator motion and were preliminarily thrown out by suborbital and space vehicles, transfer of the accumulated substances to another space vehicles, transfer of the accumulated substances to another spacecrafts, compensation of the spacecraft accumulator velocity losses caused by capture and acceleration of atmospheric air, loads and aerodynamic resistance, use of power propulsions supplied by the satellite power plat energy both of rocket type with a partial load or air consumption and electrodynamic type on basis of tether engine-generator forming a vertical satellite system and characterized in that the work of the spacecraft accumulator propulsion system is enabled by delivery of loads-energy resources with application of atmospheric gases, at that it is organized a system of interorbital circulation of loads-energy resources on energy restoration of the loads on another spacecrafts for reuse in a spacecraft accumulator.
